(19) United States
(12) Patent Application Publication
(10) Pub. No.: US 2009/0242825 A1
(43) Pub. Date: Oct. 1, 2009

(54) IRON-BASED SOFT MAGNETIC POWDER FOR DUST CORE, PRODUCTION METHOD THEREOF, AND DUST CORE

(75) Inventors: Takeshi OHWAKI, Kobe-shi (JP); Kasumi Yanagisawa, Kobe-shi (JP); Hiroyuki Mitani, Kobe-shi (JP); Satoshi Nishida, Takasago-shi (JP); Hirofumi Houjou, Takasago-shi (JP); Nobuaki Akagi, Takasago-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd), Kobe-shi (JP)

(21) Appl. No.: 12/368,413

(22) Filed: Feb. 10, 2009

(30) Foreign Application Priority Data
Mar. 25, 2008 (JP) 2008-078337

(51) Int. Cl. H01F 1/20; B05D 5/00

(52) U.S. Cl. 252/62.54; 427/127

(57) ABSTRACT

An iron-based soft magnetic powder for dust core includes an iron-based soft magnetic matrix powder, and arranged thereon in the following order, a phosphate coating and a silicone resin coating. The phosphate coating contains P, Co, Na, and S in combination with at least one of Al and Cs. This iron powder for dust core has superior mechanical strength, in which effective insulation is achieved between iron powdery particles even when the amount of an insulating material is reduced for realizing high-density molding. The iron powder for dust core is also superior in thermal stability, so that electrical insulation is maintained even after a heat treatment at high temperatures.

### BACKGROUND OF THE INVENTION

1. Field of the Invention

The present invention relates to an iron-based soft magnetic powder for dust core, which includes a soft magnetic matrix powder such as an iron powder or an iron-based alloy powder (hereinafter the both are also simply referred to as “iron powder”) and, arranged thereon, a thermally stable insulating coating. This iron-based soft magnetic powder for dust core, if molded by compaction molding, gives a dust core that is usable as a magnetic core for electromagnetic parts. The resulting dust core has superior properties such as high mechanical strength and particularly shows a high specific resistance at high temperatures.

2. Description of the Related Art

Magnetic cores for use in alternating magnetic fields should have a low core loss and a high magnetic flux density. They should also be resistant to breakage upon handling and coiling during production processes. In consideration of these points, there is known in dust core technologies a technique of coating iron powdery particles with a resin. The resulting electrically insulating resin coating suppresses the eddy-current loss and also helps to improve the mechanical strength of the magnetic core by bonding the iron powdery particles with each other by the action of the resin.

It is believed that formation of a high-density green compact is effective for improving the magnetic flux density and that annealing of the green compact at high temperatures to release the strain of the green compact is effective for reducing core loss typified by hysteresis loss. Demands have therefore been made to develop an iron powder for dust core, which effectively acts to insulate between iron powdery particles even when an insulating material is used in a less amount so as to give a high-density green compact, and which maintains good electrical insulation even after a heat treatment at high temperatures, such as annealing.

As a possible solution to these, there has been developed a technique of using a thermally stable silicone resin as an insulating material. In addition to such resinous insulating materials, a coating of vitrified compound made typically from phosphoric acid has been used as an insulating layer for a long time (Japanese Patent No. 2710152). Such inorganic insulating coatings should be more thermally stable than organic polymeric silicone resins, but they suffer from insufficient insulating properties after a heat treatment at high temperatures, such as annealing (Japanese Patent No. 4044591).

Japanese Patent No.4044591 has already been granted in Japan and has been assigned to the assignee of the present application. According to the technique disclosed therein, there is provided an iron-based soft magnetic powder which includes an iron-based soft magnetic matrix powder, and arranged thereon in the following order, a phosphate coating containing specific elements, and a silicone resin coating. This iron-based soft magnetic powder gives a dust core that has a high magnetic flux density, a low core loss, and high mechanical strength.

However, such a dust core should have further and further higher properties and should have a higher magnetic flux density, a lower core loss, and higher mechanical strength than those at the time when the application for Japanese Patent No. 4044591 was filed. The technique disclosed in Japanese Patent No. 4044591 employs annealing at high temperatures so as to reduce hysteresis loss. However, such annealing at high temperatures may lead to increased eddy-current loss to thereby cause insufficient electrical insulation of the dust core after annealing.

### SUMMARY OF THE INVENTION

Under these circumstances, an object of the present invention is to provide an iron powder for dust core which has a high magnetic flux density and high mechanical strength and is satisfactorily thermally stable so as to maintain high electrical insulating properties even after annealing at high temperatures.

The present invention has been made to achieve the object. Specifically, according to an embodiment of the present invention, there is provided an iron-based soft magnetic powder for dust core, which includes an iron-based soft magnetic matrix powder; a phosphate coating arranged on the iron-based soft magnetic matrix powder; and a silicone resin coating arranged on the phosphate coating, in which the phosphate coating contains phosphorus (P), cobalt (Co), sodium (Na), and sulfur (S) in combination with at least one of aluminum (Al) and cesium (Cs).

The phosphate coating preferably contains 0.005 to 1 percent by mass phosphorus (P), 0.005 to 0.1 percent by mass cobalt (Co), 0.002 to 0.6 percent by mass sodium (Na), 0.001 to 0.2 percent by mass sulfur (S), and at least one of 0.001 to 0.1 percent by mass aluminum (Al) and 0.002 to 0.6 percent by mass cesium (Cs), to 100 percent by mass of the total amount of the soft magnetic matrix powder and the phosphate coating.

According to another embodiment of the present invention, there is further provided a method for producing the iron-based soft magnetic powder for dust core. The method includes, in the following order, the steps of:

forming a phosphate coating on an iron-based soft magnetic matrix powder by dissolving a phosphorus-containing compound, a cobalt-containing compound, a sodium-containing compound, a sulfur-containing compound, and at least one of an aluminum-containing compound and a cesium-containing compound in at least one of water and an organic solvent to give a solution, mixing the solution with an iron-based soft magnetic matrix powder, and evaporating the solvent;

forming a silicone resin coating on the phosphate coating by dissolving a silicone resin in an organic solvent to give a silicone resin solution, mixing the silicone resin solution with the iron-based soft magnetic matrix powder bearing the phosphate coating, and evaporating the organic solvent; and

precuring the silicone resin coating by heating the resulting powder.

The phosphorus-containing compound is preferably a dihydrogen phosphate salt.

According to yet another embodiment of the present invention, there is also provided a dust core derived from the iron-based soft magnetic powder for dust core, wherein the dust core has undergone a heat treatment at 400° C. or higher. The dust core preferably has a specific resistance of 140 μΩ.m or more.

Addition of at least one of Al and Cs in addition to P, Co, Na, and S improves the thermal stability of the phosphate coating, and this gives a dust core that has higher electrical insulating properties even after high-temperature annealing and thereby has a higher specific resistance after high-temperature annealing, than known dust cores. Accordingly, the iron-based soft magnetic powder gives a high-performance dust core that satisfies all the requirements including a high magnetic flux density, a low core loss, and high mechanical strength.

These and other objects, features, and advantages of the present invention will be understood more fully from the following detailed description of the preferred embodiments. All numbers are herein assumed to be modified by the term “about.”

### DESCRIPTION OF THE PREFERRED EMBODIMENTS

As described in Japanese Patent No. 4044591, reduction in specific resistance is probably caused by an iron oxide that acts as a semiconductor, in which oxygen atom derived from phosphoric acid contained in the phosphate coating diffuses during high-temperature annealing and is thereby combined with iron to form the semiconductive iron oxide. Even after filing the application for Japanese Patent No. 4044591, the present inventors have made intensive investigations and have found that the formation of such a semiconductive oxide is effectively inhibited by adding P, Co, Na, and S to a phosphate coating and is also effectively inhibited by further adding at least one of Al and Cs. The present invention has bee made based on these findings and further investigations. Hereinafter the present invention will be illustrated in detail below.

An iron-based soft magnetic powder for dust core according to an embodiment of the present invention includes a powder and, arranged thereon in the following order, a phosphate coating (phosphate conversion coating) and a silicone resin coating. The phosphate coating helps to ensure satisfactory electrical insulation, and the silicone resin coating helps to exhibit electrical insulation more thermally stably and to exhibit satisfactory mechanical strength. The iron-based soft magnetic powder for dust core may further contain a lubricant according to necessity, to reduce friction during compaction molding, be molded by compression, and be used mainly as a core typically of a rotor or stator in a motor used under alternating current conditions.

The iron-based soft magnetic matrix powder as a matrix powder is a ferromagnetic metal powder. Exemplary iron-based soft magnetic matrix powders include pure iron powders; iron-based alloy powders such as powders of Fe—Al alloys, Fe—Si alloys, sendust, and Permalloys; and amorphous powders. These soft magnetic matrix powders may be produced typically by atomizing a material into fine particles and further pulverizing the fine particles. This process gives soft magnetic matrix powders having a median particle size (D50) of about 20 to 250 μm in an integrated particle size distribution as determined by sieve analysis. Among them, a soft magnetic matrix powder having an average particle size (median particle size) of about 50 to 150 μm is preferably used herein.

According to an embodiment of the present invention, a phosphate coating is initially arranged on the soft magnetic matrix powder. The phosphate coating is a vitrified coating formed through chemical conversion of a treatment solution mainly containing orthophosphoric acid (H₃PO₄). It should be noted that the phosphate coating contains P, Co, Na, S, and at least one of Al and Cs. This is because P, Co, Na, and S in coexistence in combination with at least one of Al and Cs effectively inhibit oxygen in the phosphate coating from being combined with iron to form a semiconductive iron oxide during high-temperature annealing and thereby effectively protect the powder from being reduced in specific resistance during the heat treatment.

For effectively suppressing the specific resistance from reducing during high-temperature annealing by the action of these elements, the phosphate coating preferably contains 0.005 to 1 percent by mass P, 0.005 to 0.1 percent by mass Co, 0.002 to 0.6 percent by mass Na, and 0.001 to 0.2 percent by mass S, in combination with at least one of 0.001 to 0.1 percent by mass Al and 0.002 to 0.6 percent by mass Cs, to 100 percent by mass of the total amount of the iron powder (matrix powder) and the phosphate coating. When the phosphate coating contains both Al and Cs, these elements are preferably contained within the above-specified ranges, respectively.

Among the elements, phosphorus (P) is combined with the surface of iron powder with the mediation of oxygen to form chemical bonding. Therefore, phosphorus, if contained in an excessively small amount, may not form sufficient chemical bonding, and this may impede the formation of a strong coating. However, some of phosphorus, if contained in an excessively large amount, may remain unreacted without contributing to chemical bonding, and this may rather reduce the bonding strength between the coating and the iron powder.

The elements Co, Na, S, Al, and Cs act to inhibit oxygen from forming a semiconductive oxide with iron during high-temperature annealing and to protect the resulting powder from having a reduced specific resistance. The combination use of Co, Na, and S maximizes these advantages. Either one of Al and Cs will do, but it should be noted that the lower limits of the contents of respective elements are minimum amounts to exhibit advantages of the combination use. In contrast, excessively large amounts of the respective elements may impede relative balance between these elements, if contained in combination, and may impede the formation of chemical bonding between phosphorus and the surface of iron powder via oxygen.

In an embodiment, the phosphate coating may further contain magnesium (Mg) and/or boron (B). The Mg and B contents in this embodiment are preferably each 0.001 to 0.5 percent by mass to 100 percent by mass of the total amount of the iron powder and the phosphate coating.

The phosphate coating preferably has a thickness of about 1 to 250 nm. A phosphate coating, if having a thickness smaller than 1 nm, may not exhibit satisfactory insulation activity. In contrast, one, if having a thickness larger than 250 nm, may exhibit a saturated insulation activity and may impede formation of a high-density green compact. The phosphate coating more preferably has a thickness of about 10 to 50 nm. The amount of the phosphate coating on the iron powder is preferably about 0.01 to 0.8 percent by mass, to 100 parts by mass of the total amount of the iron powder and the phosphate coating.

Such a phosphate coating can be obtained by dissolving, in an aqueous solvent, compounds containing elements to be contained in the coating to give a solution (treatment solution), mixing the solution with a soft magnetic matrix powder, and drying the same. Exemplary compounds usable herein include orthophosphoric acid (H₃PO₄: P source), Co₃(PO₄)₂ (Co and P source), Co₃ (PO₄)₂.8H₂O (Co and P source), Na₂HPO₄ (P and Na source), NaH₂PO₄ (P and Na source), NaH₂PO₄.nH₂O (P and Na source), Al (H₂PO₄)₃ (P and Al source), CS₂SO₄ (Cs and S source), H₂SO₄ (S source), MgO (Mg source), and H₃BO₃ (B source). Among them, sodium dihydrogen phosphate (NaH₂PO₄) is preferably used as a P source and/or a Na source. This gives a green compact that shows a high density, high strength, and a high specific resistance in good balance.

Exemplary aqueous solvents include water; hydrophilic organic solvents such as alcohols and ketones; and mixtures of these solvents. The solvents may further contain known surfactants.

A soft magnetic matrix powder bearing a phosphate coating may be formed, for example, by preparing a treatment solution having a solid content of about 0.1 to 10 percent by mass; adding about 1 to 10 parts by mass of the treatment solution to 100 parts by mass of an iron powder; mixing them with a known device such as a mixer, a ball mill, a kneader, a V-shaped mixer, or a granulator; and drying the mixture at 150° C. to 250° C. under atmospheric pressure, under reduced pressure, or in vacuo.

Next, a silicone resin coating is arranged. Upon the completion of crosslinking/curing reaction of the silicone resin, the powdery particles are firmly combined with each other to give a green compact having increased mechanical strength. Additionally, the silicone resin forms thermally stable Si—O bonding to give a highly thermally stable insulating coating. The silicone resin is preferably one containing trifunctional units (T-units: RSiX₃ wherein X is a hydrolyzable group) in an amount lager than that of bifunctional units (D-units: R₂SiX₂ wherein X is as defined above), because a silicone resin that cures slowly may give a sticky coating on the powder, and this may impede smooth handling. However, a silicone resin containing a large amount of tetrafunctional units (Q-units: SiX₄ wherein X is as defined above) is not preferred, because the powdery particles are excessively firmly bonded with each other upon precuring and are difficult to use in the subsequent molding process. Accordingly, a silicone resin for use herein preferably has a T-unit content of 60 percent by mole or more, more preferably 80 percent by mole or more, and most preferably 100 percent by mole.

Of silicone resins, methylphenylsilicone resins wherein R is methyl group or phenyl group are generally used. It is believed that, of such methyl phenyl silicone resins, one containing a larger amount of phenyl group shows higher thermal stability. However, it has been found that the presence of phenyl group is not so effective in annealing at such high temperatures as to be intended in the present invention. This is provably because the bulky phenyl group disturbs the dense vitrified network structure, and this may rather reduce the thermal stability and reduce the action of inhibiting the formation of a compound with iron. Accordingly, silicone resins for use herein are preferably methylphenylsilicone resins containing 50 percent by mole or more of methyl group (for example, KR 255 and KR 311 supplied by Shin-Etsu Chemical Co., Ltd.), more preferably methylphenylsilicone resins containing 70 percent by mole or more of methyl group (for example, KR 300 supplied by Shin-Etsu Chemical Co., Ltd.), and further preferably methylsilicone resins containing no phenyl group (for example, KR 251, KR 400, KR 220L, KR 242A, KR 240, KR 500, and KC 89 supplied by Shin-Etsu Chemical Co., Ltd.; and SR 2400 supplied by Dow Corning Toray Co., Ltd.). The ratio of methyl group to phenyl group, and the functionality of such silicone resins can be analyzed typically by Fourier transformation infrared spectrometry (FT-IR).

The amount of the silicone resin coating is preferably 0.05 to 0.3 percent by mass to 100 percent by mass of the total amount of the soft magnetic matrix powder, the phosphate coating, and the silicone resin coating. A silicone resin coating, if in an amount of smaller than 0.05 percent by mass, may not exhibit sufficient insulation properties and may show a low electrical resistance. In contrast, a silicone resin coating, if in an amount of more than 0.3 percent by mass may impede the formation of a high-density green compact.

The silicone resin coating may be formed by dissolving a silicone resin in an organic solvent such as an alcohol or a petroleum organic solvent (e.g., toluene or xylene) to give a solution; mixing the solution with the iron powder bearing the phosphate coating; and evaporating the organic solvent. The silicone resin coating may be formed typically but not limitatively by preparing a resin solution having a solid content of about 2 to 10 percent by mass; mixing about 0.5 to 10 parts by mass of the resin solution with 100 parts by mass of the soft magnetic matrix powder bearing the phosphate coating; and drying the mixture. A resin solution, if used in an amount of less than 0.5 part by mass, may give a nonuniform coating. In contrast, a resin solution, if used in an amount of more than 10 parts by mass, may invite a longer duration to dry the mixture or cause insufficient drying. The resin solution may have been heated according to necessity before mixing with the soft magnetic powder. The mixing device for use herein may be as above.

In the drying step, it is preferred to evaporate the organic solvent thoroughly by heating at such a temperature that the organic solvent evaporates and that is lower than the curing temperature of the silicone resin. Specifically, the drying is preferably conducted at a temperature of about 60° C. to 80° C. when an alcohol or petroleum organic solvent as mentioned above is used. The dried powdery particles are preferably allowed to pass through a sieve having an aperture of about 300 to 500 μm so as to remove aggregated lumpy particles.

The thickness of the silicone resin coating is preferably 1 to 200 nm and more preferably 20 to 150 nm. The total thickness of the phosphate coating and the silicone resin coating is preferably 250 nm or less. A total thickness of the phosphate coating and the silicone resin coating of more than 250 nm may cause the dust core to have a further reduced magnetic flux density.

It is recommended to precure the silicone resin coating after drying. As used herein “precuring” refers to a treatment to complete the softening process of the silicone resin coating upon curing under conditions where the resulting powdery particles as a powder. This precuring treatment enables the soft magnetic matrix powder to flow satisfactorily during warm forming (carried out at about 100° C. to 250° C.). More specifically, the silicone resin coating can be easily and conveniently precured by a process of heating the soft magnetic powder bearing the silicone resin coating at a temperature around the curing temperature of the silicone resin for a short period of time. However, a process of using an agent (curing agent) is also usable. Precuring differs from curing (complete curing) in that powdery particles after precuring are not completely bonded with each other and are easily separable from each other, whereas the resin is cured and the powdery particles are firmly bonded with each other after complete curing. As used herein “complete curing” refers to heating and curing at high temperatures which is carried out after molding of the powder). The complete curing allows the compact (molded article) to have higher strength.

The silicone resin is precured and the resulting powdery particles are separated from each other (crushed) to give a powder that can flow satisfactorily. The resulting powder is as loose as sand and can be smoothly charged into a molding die for compacting. If precuring is not conducted, the powdery particles may be bonded with each other typically upon warm forming and may be difficult to charge into a die smoothly within a short time. In real operation, it is very meaningful to improve the handleability of the powder to be used. In addition, it has been found that the resulting dust core, if prepared through precuring, has a further higher specific resistance. While remaining unknown, this is probably because adhesion between the coating and the iron powder upon curing increases.

The precuring, if carried out by heating for a short period of time, is preferably conducted by heating at 100° C. to 200° C. for 5 to 100 minutes and more preferably conducted by heating at 130° C. to 170° C. for 10 to 30 minutes. The soft magnetic powder after precuring is also preferably sieved through a sieve, as described above.

In an embodiment, the iron-based soft magnetic powder for dust core may further contain a lubricant. The lubricant acts to reduce the frictional drag between soft magnetic powder particles or between the soft magnetic powder and the inner wall of the die upon compaction molding of the soft magnetic powder for dust core. This prevents die dragging of the compact or heat generation upon molding. For effectively exhibiting these activities, the lubricant content in the powder is preferably 0.2 percent by mass or more based on the total amount of the powder. However, the lubricant content is preferably 0.8 percent by mass or less, because an excessive lubricant, if contained in the powder, may impede the formation of a high-density green compact. When compaction molding is conducted after applying a lubricant to the inner wall of a die (die wall lubrication process), it is acceptable to use the lubricant in an amount of less than 0.2 percent by mass.

The lubricant may be any of known or common lubricants. Exemplary lubricants include powders of metal salts of stearic acid, such as zinc stearate, lithium stearate, and calcium stearate; paraffins; waxes; and natural or synthetic resin derivatives.

The iron-based soft magnetic powder for dust core is naturally used for the production of a dust core, and the dust core produced therefrom is also included within the scope of the present invention. To produce the dust core, initially, the power is subjected to compaction molding. The compaction molding can be carried out according to a common or known procedure not particularly limited.

The compaction molding is carried out preferably at a compacting pressure (contact pressure) of 490 MPa to 1960 MPa and more preferably at a compacting pressure of 790 MPa to 1180 MPa. The compaction molding is particularly preferably carried out at a compacting pressure of 980 MPa or more so as to easily give a dust core which has a density of 7.50 g/cm³ or more and has high strength and superior magnetic properties such as magnetic flux density. The molding can be carried out through molding at room temperature or warm forming (100° C. to 250° C.). Among such forming procedures, warm forming through the die wall lubrication process is preferred, because it gives a dust core having higher strength. The strength of the dust core is preferably 90 MPa or more, as determined by the method described in the after-mentioned examples.

The compact (molded article) is subjected to high-temperature annealing so as to reduce the hysteresis loss of the dust core. The annealing temperature is preferably 400° C. or higher. Unless deterioration of specific resistance occurs, annealing is preferably conducted at higher temperatures. The atmosphere during annealing is not particularly limited but is preferably an atmosphere of inert gas such as nitrogen gas. The annealing duration is not particularly limited, unless deterioration of specific resistance occurs, but is preferably 20 minutes or more, more preferably 30 minutes or more, and further preferably 1 hour or more. The dust core after annealing preferably has a specific resistance of 140 μΩ.m or more.

### EXAMPLES

The present invention will be illustrated in further detail with reference to several examples below. It should be noted, however, the following examples are illustrated only by way of example and never construed to limit the scope of the present invention. All modifications, alternations, and changes are possible unless departing from the scope and fair meaning of the present invention. All parts and percentages are by mass, unless otherwise specified.

### Example 1

A pure iron powder (Kobe Steel, Ltd.; ATOMEL 300 NH, having an average particle size of 80 to 100 μm) used as a soft magnetic matrix powder was allowed to pass through a sieve with an aperture of 300 μm. Independently, a treatment solution was prepared by mixing 1000 parts of water, 88.5 parts of Na₂HPO₄, 181 parts of H₃PO₄, 61 parts of H₂SO₄, 30 parts of Co₃(PO₄)₂, and 44 parts of Cs₂SO₄, and diluting the resulting mixture by ten-folds. To 200 parts of the pure iron powder was added 10 parts of the treatment solution, the mixture was agitated with a V-shaped mixer for 30 minutes or longer, dried at 200° C. in the air for 30 minutes, and allowed to pass through a sieve with an aperture of 300 μm.

Next, a resin solution with a solid content of 4.8% was prepared by dissolving a silicone resin “KR 220L” (Shin-Etsu Chemical Co., Ltd.) having a methyl group content of 100 percent by mole and a T-unit content of 100 percent by mole in toluene. The resin solution was mixed with the above-prepared iron powder so that the resin solid content be 0.15%, the mixture was dried by heating in a heating oven at 75° C. in the air for 30 minutes, and allowed to pass through a sieve with an aperture of 300 μm, followed by precuring at 150° C. for 30 minutes.

Next, a dispersion of zinc stearate in ethanol was applied to a die, and the above iron powder was placed therein, followed by compacting at room temperature (25° C.) and a compacting pressure of 980 MPa. The compact had dimensions of 31.75 mm long, 12.7 mm wide, and about 5 mm thick. The compact was then annealed at 600° C. in a nitrogen gas atmosphere for 1 hour at a rate of temperature rise of about 5° C. per minute. The annealed compact was cooled in the furnace (oven).

The contents of respective elements constituting the compact are shown in Table 2. These contents were quantitatively determined by inductively coupled plasma emission spectrochemical analysis.

The density, transverse rupture strength (transverse intensity as determined by a three-point bending test in accordance with the method described in JPMA M 09-1992 specified by Japan Powdery Metallurgy Association), and specific resistance of the compact were measured, and the results are shown in Table 3.

### Examples 2 to 4 and Comparative Example 1

A series of green compacts was prepared by the procedure of Example 1, except for employing treatment solutions having the compositions indicated in Table 1. The element contents, green density, transverse rupture strength (green strength), and specific resistance of the green compacts were measured, and the results are shown in Tables 2 and 3.

TABLE 1

| | Added elements in phosphate | | | | | | | |
|---|---|---|---|---|---|---|---|---|
| No. | coating | Na₂HPO₄ | NaH₂PO₄ | H₃PO₄ | Co₃(PO₄)₂ | H₂SO₄ | Cs₂SO₄ | Al(H₂PO₄)₃ |
| Example 1 | P, Co, Na, S, Cs | 88.5 | — | 181 | 30 | 61 | 44 | — |
| Example 2 | P, Co, Na, S, Cs | — | 150 | 181 | 30 | 61 | 44 | — |
| Example 3 | P, Co, Na, S, Al | 88.5 | — | 181 | 30 | 61 | — | 78 |
| Example 4 | P, Co, Na, S, Cs, Al | 88.5 | — | 181 | 30 | 61 | 44 | 78 |
| Comparative Example 1 | P, Co, Na, S | 88.5 | — | 181 | 30 | 61 | — | — |

TABLE 2

| No. | P | Na | S | Co | Cs | Al |
|---|---|---|---|---|---|---|
| Example 1 | 0.042 | 0.025 | 0.012 | 0.014 | 0.032 | — |
| Example 2 | 0.043 | 0.026 | 0.013 | 0.014 | 0.031 | — |
| Example 3 | 0.043 | 0.026 | 0.010 | 0.014 | — | 0.009 |
| Example 4 | 0.041 | 0.024 | 0.012 | 0.015 | 0.032 | 0.008 |
| Comparative Example 1 | 0.044 | 0.027 | 0.013 | 0.015 | — | — |

TABLE 3

| | Green density | Transverse rupture | Specific resistance |
|---|---|---|---|
| No. | (g/cm³) | strength (MPa) | (μΩ · m) |
| Example 1 | 7.52 | 92 | 141.0 |
| Example 2 | 7.53 | 93 | 144.4 |
| Example 3 | 7.50 | 90 | 141.9 |
| Example 4 | 7.50 | 93 | 144.9 |
| Comparative | 7.51 | 93 | 127.1 |
| Example 1 | | | |

Table 3 demonstrates that the compacts according to Examples 1 to 4 have a high specific resistance after high-temperature annealing of 140 μΩ.m or more, as compared to the compact according to Comparative Example 1. The compacts according to Example 1 and Example 2 differ with each other only in P/Na source. The results demonstrate that the compact according to Example 2 using NaH₂PO₄ as the P/Na source shows more satisfactorily-balanced green density, transverse rupture strength, and specific resistance and has higher performance than the compact according to Example 1. The compact according to Example 4 using Al and Cs in combination shows the highest specific resistance after annealing among them.

Additionally, cross sections of these compacts were observed under a transmission electron microscope, and the thicknesses of their phosphate coatings and silicone resin coatings were measured. The compacts according to Examples 1 to 4 do not differ much in thickness from the compact according to Comparative Example 1, and the phosphate coatings have thicknesses of from 30 to 35 nm, and the silicone resin coatings have thicknesses of from 100 to nm.

Iron-based soft magnetic powders for dust core according to embodiments of the present invention each have a highly thermally stable insulating coating and thereby give dust cores that will exhibit a high magnetic flux density, a low core loss, and high mechanical strength. The resulting dust cores are useful as cores in rotors and stators of motors.

What is claimed is:

1. An iron-based soft magnetic powder for dust core, comprising:
an iron-based soft magnetic matrix powder;
a phosphate coating arranged on the iron-based soft magnetic matrix powder; and
a silicone resin coating arranged on the phosphate coating,
wherein the phosphate coating contains phosphorus (P), cobalt (Co), sodium (Na), and sulfur (S) in combination with at least one of aluminum (Al) and cesium (Cs).

2. The iron-based soft magnetic powder according to claim 1, wherein the phosphate coating comprises:
0.005 to 1 percent by mass phosphorus (P),
0.005 to 0.1 percent by mass cobalt (Co),
0.002 to 0.6 percent by mass sodium (Na),
0.001 to 0.2 percent by mass sulfur (S), and
at least one of 0.001 to 0.1 percent by mass aluminum (Al) and 0.002 to 0.6 percent by mass cesium (Cs), to 100 percent by mass of the total amount of the soft magnetic matrix powder and the phosphate coating.

3. A method for producing the iron-based soft magnetic powder for dust core of one of claims 1 and 2, the method comprising, in the following order, the steps of:
forming a phosphate coating on an iron-based soft magnetic matrix powder by dissolving a phosphorus-containing compound, a cobalt-containing compound, a sodium-containing compound, a sulfur-containing compound, and at least one of an aluminum-containing compound and a cesium-containing compound in at least one of water and an organic solvent to give a solution, mixing the solution with an iron-based soft magnetic matrix powder, and evaporating the solvent;
forming a silicone resin coating on the phosphate coating by dissolving a silicone resin in an organic solvent to give a silicone resin solution, mixing the silicone resin solution with the iron-based soft magnetic matrix powder bearing the phosphate coating, and evaporating the organic solvent; and
precuring the silicone resin coating by heating the resulting powder.

4. The method according to claim 3, wherein the phosphorus-containing compound is a dihydrogen phosphate salt.

5. A dust core derived from the iron-based soft magnetic powder of claim 1, wherein the dust core has undergone a heat treatment at 400° C. or higher.

6. The dust core according to claim 5, wherein the dust core has a specific resistance of 140 μΩ.m or more.
